(19) United States
(12) Patent Application Publication
(10) Pub. No.: US 2017/0204297 A1
(43) Pub. Date: Jul. 20, 2017

(54) POLYVINYLIDENE FLUORIDE RESIN ADHESIVE FILM

(71) Applicant: DENKA COMPANY LIMITED, Tokyo (JP)

(72) Inventors: Mizuki HASUMI, Ichihara-City, Chiba (JP); Fukumu KOMODA, Isesaki-City, Gunma (JP)

(73) Assignee: DENKA COMPANY LIMITED, Tokyo (JP)

(21) Appl. No.: 15/326,983

(22) PCT Filed: Jul. 13, 2015
(86) PCT No.: PCT/JP2015/070088

§ 371 Date: Feb. 14, 2017

(30) Foreign Application Priority Data
Jul. 14, 2014 (JP) 2014-144530

(51) Int. Cl. C09J 7/02; B29C 73/10; C09J 133/08; B32B 27/30

(52) U.S. Cl. CPC C09J 7/0267; B32B 27/304; B29C 73/10; C09J 133/08; C09J 7/0296; B32B 2255/26; B32B 2405/00; C09J 2427/006; C09J 2433/006; C09J 2433/00; C09J 2205/114

(57) ABSTRACT

Provided is a polyvinylidene fluoride resin adhesive film that restores the transparency of a damaged transparent base material by smoothing the surface irregularity generated by damaging and has surface-protecting properties superior in weather fastness and stain resistance. A polyvinylidene fluoride resin adhesive film, comprising a resin composition layer containing a polyvinylidene fluoride resin in an amount of 0 to 50 mass % and a polymethacrylic ester resin in an amount of 100 to 50 mass % (100% in total) and additionally an ultraviolet absorbent in an amount of 0.1 to 15 mass % with respect to the resin components therein, a resin composition layer laminated on one face thereof, containing a polyvinylidene fluoride resin in an amount of 100 to 50 mass % and a polymethacrylic ester resin in an amount of 0 to 50 mass % (100% in total) and an acrylic adhesive layer formed on the other face thereof.

### TECHNICAL FIELD

The present invention relates to a polyvinylidene fluoride resin adhesive film that has a transparency-restoring action that is suited for surface repair and protection of various structures used indoors and outdoors.

### BACKGROUND ART

Polyvinyl chloride films, polymethacrylic ester films, fluorine-based film and the like have been used with various paints as surface protective films for interior and exterior parts. Because of their superior weather fastness, applications of these protective films are directed to many objects including wall papers, interior parts of elevators and vehicles, roofing materials, wall materials, rainwater gutters, garage roofings, sun rooms, agricultural materials, signboards, signs, and marks.

The protective films above were used separately in various applications according to their prices and properties. The base materials to be adhered are also diversified and examples thereof include widely plastic materials such as of polyvinyl chloride, polycarbonate, polymethyl methacrylate, acrylonitrile-butadiene-styrene copolymers, and FRPs, metals such as aluminum foil and steel plate, plywoods, glasses, and the like.

Fluorine-based resin films are generally used as the protective films above in the fields demanding high weather fastness and Patent Document 1 proposes a laminate film having a layer containing polyvinylidene fluoride as the principal component and a layer containing a polymethacrylic ester resin as the principal component.

### CITATION LIST

### Patent Literature

[Patent Document 1] JP-A No. H08-267675

### SUMMARY OF THE INVENTION

### Technical Problem

An object of the present invention is to provide a polyvinylidene fluoride resin adhesive film that is superior in stain resistance, weather fastness, and tackiness, suited for surface repair and protection of various structures used indoors and outdoors, particularly suited for repair of a surface-damaged transparent base material.

### Solution to Problem

Specifically, the present invention relates to the followings:

(1) A polyvinylidene fluoride resin adhesive film, including a layer B, a layer A laminated on one face thereof and an acrylic adhesive layer formed on the other face thereof, wherein: the layer A is a resin composition containing a polyvinylidene fluoride resin in an amount of 100 to 50 mass % and a polymethacrylic ester resin in an amount of 0 to 50 mass % (100% in total); and the layer B is a resin composition containing a polyvinylidene fluoride resin in an amount of 0 to 50 mass % and a polymethacrylic ester resin in an amount of 100 to 50 mass % (100% in total) and additionally an ultraviolet absorbent in an amount of 0.1 to 15 mass % with respect to the resin components of the layer B.
(2) The polyvinylidene fluoride resin adhesive film described in (1), wherein the layer A has a thickness of 5 μm to 100 μm and the layer B has a thickness of 5 μm to 100 μm.
(3) The polyvinylidene fluoride resin adhesive film described in (1) or (2), wherein the ultraviolet absorbent contained in the layer B is a triazine compound.
(4) The polyvinylidene fluoride resin adhesive film described in any one of (1) to (3), wherein the acrylic adhesive layer has a thickness of 10 μm to 100 μm.
(5) The polyvinylidene fluoride resin adhesive film described in any one of (1) to (4), wherein the acrylic adhesive has a storage modulus at 25° C. and 1.0 Hz of 1.0×10⁴ to 1.0×10⁶ Pa and a tan δ at 100° C. and 1.0 Hz of 0.6 or less.
(6) The polyvinylidene fluoride resin adhesive film described in any one of (1) to (5), wherein the surface of the acrylic adhesive layer of the polyvinylidene fluoride resin adhesive film is protected with a separator.
(7) An adhesive film for repair of a transparent base material, including the polyvinylidene fluoride resin adhesive film described in any one of (1) to (6).
(8) A repair method, employing the adhesive film for repair of a transparent base material described in (7).

### Advantageous Effects of Invention

The polyvinylidene fluoride resin adhesive film according to the present invention is superior in adhesiveness and long-term weather fastness and also in stain resistance and solvent resistance and repellent to aqueous and oil inks and dusts if they may be attached thereto. As it is also superior in the efficiency of smoothing the surface irregularity of a damaged base material, it is favorable as a repair film and can be used favorably as a repair film for wall papers and interior parts such as of elevators and vehicles and also for exterior construction materials such as roofing materials, wall materials, and rainwater gutters, particularly transparent base materials for exterior use.

### DESCRIPTION OF EMBODIMENTS

Hereinafter, favorable embodiments of the present technology will be described. The embodiments described below are only some typical examples of the present technology and it should be understood that the scope of the technology is not restricted thereby at all.

The polyvinylidene fluoride resin for use in the present invention is a homopolymer of vinylidene fluoride or a copolymer of vinylidene fluoride with a vinylidene fluoride-copolymerizable monomer. Examples of the copolymerizable monomers that can be used include vinyl fluoride, tetrafluoroethylene, hexafluoropropylene, hexafluoroisobutylene, trifluorochloroethylene, various fluoroalkyl vinyl ethers, and the like and these monomers may be used alone or in combination of two or more.

Methacrylic ester resins include homopolymers of methyl methacrylate and copolymers of methyl methacrylate and other copolymerizable monomers. Examples of the copolymerizable monomers include methacrylic esters such as butyl methacrylate and ethyl methacrylate, acrylic esters and the like.

The blending ratio of the polyvinylidene fluoride resin to the polymethacrylic ester resin in layer A is 100 to 50/0 to 50 mass %, preferably 95 to 52/5 to 48 mass %, more preferably 85 to 55/15 to 45 mass %. It is possible, when the blending ratio of the polyvinylidene fluoride resin is 50 mass % or more, to improve the properties of the polyvinylidene fluoride resin such as weather fastness and stain resistance.

The blending ratio of the polyvinylidene fluoride resin to the polymethacrylic ester resin in layer B is 0 to 50/100 to 50 mass %, preferably 5 to 48/95 to 52 mass %, more preferably 15 to 45/85 to 55 mass %. It is possible, when the blending ratio of the polymethyl methacrylate is 50 mass % or more, to improve the adhesiveness to the adhesive layer.

The thicknesses of layer A, layer B, and the entire film are preferably, respectively 5 to 100 μm (layer A), 5 to 100 μm (layer B), and 10 to 200 μm (entire film). More preferably, the layer A has a thickness of 5 to 80 μm and the layer B 10 to 100 μm, and still more preferably, the layer A has a thickness of 10 to 60 μm and the layer B 13 to 80 μm. It is possible to improve the function as protective layer, when the layer A has a thickness of 5 μm or more, and to reduce the cost thereof, when it has a thickness of 100 μm or less. It is possible to improve the adhesiveness to the adhesive, when the layer B has a thickness of 5 μm or more, and to reduce the cost thereof, when it has a thickness of 100 μm or less.

An example of the method of improving further the weather fastness (in particular, in ultraviolet ray-blocking efficiency) of the base material in the state of transparent film is to add a triazine-, benzotriazole-, benzophenone-, or salicylic acid derivative-based ultraviolet absorbent to the layer B in an amount of 0.1 to 15 mass % with respect to 100 parts of the resin components in layer B. In particular, a triazine-based ultraviolet absorbent is preferable from the viewpoint of ultraviolet ray-blocking efficiency. It is possible to improve the weather fastness further when the addition amount thereof is 0.1 mass % or more and it is possible, when the addition amount is 15 mass % or less, to prevent bleeding out of the ultraviolet absorbent on the film surface and also deterioration in the adhesiveness to acrylic adhesive and in adhesive physical properties such as adhesive strength and ball tack and additionally to reduce the cost.

Hereinafter, a method for producing the polyvinylidene fluoride resin film according to the present invention will be described. The film according to the present invention, which comprises two layers, is characterized in that at least one layer of them is bonded to the other integrally by melt extrusion molding. A common single- or twin-screw extruder is used for the melt extrusion molding. Methods of bonding multiple layers integrally include the following methods. T-die coextrusion molding methods of producing a multilayer by adhering resins in a molten state using multiple extrusion molding machines include a method of forming multiple resin layers in the sheet shape and combining and adhering them with each other (multimanifold die method) and a method of adhering multiple resins with each other and then expanding the mixture into a sheet shape (feedblock die method). It is also possible to produce a multilayered film by a method of using a circular die (inflation molding method

Alternatively, it is also possible to employ a method of molding one of the multiple integrally bonded layers previously into a film shape and extrusion molding the other layers thereon and bonding them under pressure by heat or with an adhesive agent (generally, an adhesive agent is applied previously) repeatedly (extrusion lamination method). Although there is a method of producing both layers previously into a film shape and then integrating them using heat or an adhesive agent, the method is less advantageous in step and cost than the methods described above and it is technologically difficult to integrate the layers when the films are thin.

The thickness of the acrylic adhesive coated on layer B is preferably 10 to 100 μm, more preferably 20 to 60 μm. It is possible, when the thickness of the acrylic adhesive coated on layer B is 10 μm or more, to improve the followability to the surface irregularity of the adherend. In addition, it is possible, when the thickness of the acrylic adhesive coated on layer B is 100 μm or less, to prevent insufficient drying in the adhesive drying step and make the resulting product show its adhesive property sufficiently.

The acrylic adhesive preferably has a storage modulus at 25° C. and 1.0 Hz of 1.0×10⁴ to 1.0×10⁶ Pa, and a tan δ at 100° C. and 1.0 Hz of 0.6 or less. It more preferably has a storage modulus at 25° C. and 1.0 Hz of 5.0×10⁴ to 5.0×10⁵ Pa and a tan δ at 100° C. and 1.0 Hz of 0.4 or less. When the storage modulus is 1.0×10⁴ Pa or more, the adhesive has an improved cohesive force and it is thus possible to prevent displacement or separation of the adhesive film from the adherend, after the adhesive film is bonded to the adherend. When the storage modulus is 1.0×10⁶ Pa or less, the adhesive is favorably flexible and it is thus possible to improve the followability to the surface irregularity of the adherend. When the tan δ is 0.6 or less, the adhesive film shows improved heat resistance, it is possible to prevent displacement or separation of the adhesive film on the adherend, for example, by the heat of sunlight after the adhesive film is bonded to the adherend.

The storage modulus and the tan δ can be determined, for example, using a viscoelastometer manufactured by Rheometric Scientific. The storage modulus, as used in the present invention, is a storage modulus G′ in the shearing mode at a frequency of 1.0 Hz and at 25° C., while the tan δ is a value obtained from the ratio (G″/G′) of the storage modulus G′ in the shearing mode at a frequency 1.0 Hz and at 100° C. to the loss modulus G″.

The haze of the acrylic adhesive, which is a value obtained by measuring the adhesive of 5 cm square having a thickness of 1.5 mm according to ASTM D1003 using a haze meter (type: NDH-1001DP, manufactured by Nippon Denshoku), is 0 to 30%, preferably 0 to 20%. When the haze of the acrylic adhesive is 30% or less, the adhesive film has a haze of 30% or less when it is coated on the vinylidene fluoride resin film, thus improving the transparency when it is bonded to a transparent base material.

A typical example of the acrylic adhesive used is a copolymer of at least one of C2 to C12 alkyl esters of acrylic acid such as ethyl acrylate, n-propyl acrylate, n-butyl acrylate, isobutyl acrylate, n-pentyl acrylate, 2-methylbutyl acrylate, n-hexyl acrylate, 2-ethylhexyl acrylate, n-octyl acrylate, isooctyl acrylate, n-nonyl acrylate, and isononyl acrylate (monomer A) and at least one functional group-containing acrylic monomer such as acrylic acid, methacrylic acid, acrylamide, N-methylolacrylamide, 2-hydroxyethyl acrylate, or 2-hydroxyethyl methacrylate (monomer B). The copolymerization ratio of the monomer A to the monomer B is in the range of 99.9/0.1 to 70/30 mass %, preferably in the range of 99/1 to 75/25 mass %.

A particularly favorable acrylic copolymer has a copolymerization ratio of butyl acrylate (BA) to acrylic acid (AA) in the range of 99.9/0.1 to 70/30 mass %, preferably in the range of 99.5/0.5 to 80/20 mass %. It becomes possible, when the content of AA is 0.1 mass % or more, to control the adhesion physical properties easily together with a crosslinking agent. When the content of AA is 30 mass % or less, the polymer has a lower glass transition point (Tg), thus becomes more adhesive to the adherend at low temperature and improved in processability.

The acrylic copolymer preferably has a weight-average molecular weight (Mw) of 200,000 to 1,000,000, more preferably 400,000 to 800,000 and the molecular weight can be regulated according to the amount of the polymerization initiator added and also by addition of a chain-transfer agent. When the weight-average molecular weight (Mw) is 200,000 or more, the acrylic copolymer has an improved cohesive force and thus, it is possible to prevent staining of the adhesive residue on the adherend and separation of the adhesive film. Alternatively when it is 1,000,000 or less, the acrylic copolymer is favorably flexible, leading to improvement of the followability of the adhesive film to the surface irregularity of the adherend.

The acrylic adhesive may contain, as needed, additives such as crosslinking agents, tackifiers, ultraviolet absorbents, and photostabilizers.

Examples of the crosslinking agents include isocyanate-based crosslinking agents, epoxy-based crosslinking agents, amine-based crosslinking agents, and the like. These crosslinking agents may be used alone or as two or more kinds of them are mixed. A particularly favorable crosslinking agent is an isocyanate-based crosslinking agent and such an isocyanate-based crosslinking agent is used in an amount of 0.3 to 4 parts by mass, preferably 0.5 to 3 parts by mass, with respect to 100 parts by mass of the acrylic adhesive. When the content of the isocyanate-based crosslinking agent is 0.3 part or more by mass, the acrylic adhesive has an improved cohesive force and it is possible to prevent staining of the adhesive residue on the adherend when the adhesive film is separated from the adherend and thus to improve the re-peeling efficiency. Alternatively when the content of the isocyanate-based crosslinking agent is 4 part or less by mass, the acrylic adhesive becomes favorably flexible and it is possible to improve the followability of the adhesive film to the surface irregularity of the adherend and to prevent incorporation of air bubbles when the adhesive film is bonded.

Typical examples of the isocyanate-based crosslinking agents include polyvalent isocyanate compounds such as 2,4-tolylene diisocyanate, 2,6-tolylene diisocyanate, 1,3-xylylene diisocyanate, 1,4-xylene diisocyanate, diphenylmethane-4,4′-diisocyanate, diphenylmethane-2,4′-diisocyanate, 3-methyldiphenylmethane diisocyanate, hexamethylene diisocyanate, isophorone diisocyanate, dicyclohexylmethane-4,4′-diisocyanate, dicyclohexylmethane-2,4′-diisocyanate, lysine isocyanate, and the like. These crosslinking agents may be used alone or as two or more kinds of them are mixed.

The tackifier can be selected, as its softening point and compatibility with other components are taken into consideration. Examples thereof include terpene resins, rosin resins, hydrogenated rosin resins, coumarone-indene resins, styrenic resins, aliphatic petroleum resins, alicyclic petroleum resins, terpene-phenol resins, xylene resins, other aliphatic and aromatic hydrocarbon resins, and the like. These resins may be used alone or as two or more kinds of them are mixed.

The ultraviolet absorbent can be selected, for example, as its ultraviolet ray-absorbing efficiency and compatibility to the acrylic adhesive used are taken into consideration. Examples thereof include hydroquinone-, benzotriazole-, benzophenone-, triazine- and cyanoacrylate-based absorbents, and the like. These absorbents may be used alone or as two or more kinds of them are mixed.

The photostabilizer can be selected, for example, as its compatibility to the acrylic adhesive used and thickness are taken into consideration. Examples thereof include hindered amine compounds, hindered phenol compounds, benzoate compounds, nickel complex salt compounds, and the like. These photostabilizers may be used alone or as two or more kinds of them are mixed.

The haze of the polyvinylidene fluoride resin adhesive film according to the present invention, which is a value obtained by using a polyvinylidene fluoride resin adhesive film of 5 cm square (resin layer thickness: 45 μm, acrylic adhesive layer thickness: 50 μm) as the test sample using a haze meter (type NDH-1001DP manufactured by Nippon Denshoku), is 0 to 30% and such an adhesive film does not impair the transparency of a transparent base material used outdoors for example of a plastic resin such as an acrylic or polycarbonate resin or glass, when it is applied thereon. Further, such an adhesive film is favorably followable to the surface irregularity of a damaged transparent base material and thus suppresses deterioration in transparency due to the damage on the transparent base material surface. Accordingly, it is thus favorable as an adhesive film for repair of transparent base materials. The haze is more preferably 0 to 20% and it is possible, when it is 30% or less, to improve the transparency of the adherend damaged transparent base material (plastic, glass).

The vinylidene fluoride resin adhesive film according to the present invention may have a separator layer formed on the surface of the acrylic adhesive layer.

A typical example of the separator used is a known common separator such as a PET film having a silicone-based release agent coated on the surface or a laminate film of paper and polyethylene having a silicone-based release agent coated on the polyethylene side.

The acrylic adhesive layer can be formed by a common method and is prepared, for example, by a method of coating and drying an adhesive directly on the layer B of the vinylidene fluoride resin film (direct coating method) or a method of applying an adhesive on a separator and, after drying, transferring the adhesive over the separator onto the layer B of the vinylidene fluoride resin film (transfer coating method).

A known common primer may be used, as needed, for improvement of the adhesiveness between the vinylidene fluoride resin film and the acrylic adhesive.

### EXAMPLES

Hereinafter, the present invention will be described in detail with reference to Examples, but it should be understood that the present invention is not restricted by these Examples.

The polyvinylidene fluoride resin used was KYNAR 720 (product name, hereinafter, referred to as K-720) produced by Arkema. The polymethacrylic ester resin used was an acrylic rubber-containing polymethyl methacrylate resin, Hi-PET HBS (product name, hereinafter referred to as HBS) produced by Mitsubishi Rayon Co., Ltd. The ultraviolet absorbent used was a triazine- or benzotriazole-based compound. A mixture of K-720, HBS, and the ultraviolet absorbent, which is a blend thereof at the mass ratio shown in Table 1 or 2, was used after it was previously melted and pelletized in a 30 mmφ counter-rotating twin-screw extruder. The acrylic adhesive used was a blend of a copolymer of butyl acrylate (BA) and acrylic acid (AA) (BA/AA=90/10, solid matter: 35%) in an amount of 100 parts by mass and an isocyanate-based crosslinking agent (solid matter: 45%) in an amount (parts by mass) shown in Table 1 or 2.

### <Stain Resistance>

The layer A side of the polyvinylidene fluoride resin adhesive film was painted with an oil-based ink (Magic ink, manufactured by Teranishi Chemical Industry Co., Ltd.) in an area of 1 cm square and, after drying, the area was scrubbed with a piece of gauze 30 times and the state of the ink remaining thereon was evaluated by visual observation in the following manner:

⊚: Ink completely removed
◯: Ink removed, but only with scrubbing mark
Δ: Ink partially removed and partially unremoved (ink removed with scrubbing mark)
x: Mostly unremoved

### <Substrate-Protecting Efficiency>

The polyvinylidene fluoride resin was bonded to a PVC sheet and subjected to the following tests, to give a change of yellowness index (Δb).

### Weather Resistance Acceleration Test of JIS A 1415

Testing methods for yellowness index and change of yellowness index of JIS K 7103

Change of Yellowness index (Δb)=Post-exposure yellowness index/Initial yellowness index

### <Adhesiveness to Adhesive Agent>

The acrylic adhesive layer of two polyvinylidene fluoride resin adhesive films were adhered to and separated from each other repeatedly, until one or both of the adhesive layers are peeled off from the polyvinylidene fluoride resin films.

The evaluation results are grouped into the followings:

⊚: The adhesive layers remained intact even after the adhesive layers are adhered and separated repeatedly in the same region ten times.
◯: The adhesive layers remained intact even after the adhesive layers are adhered and separated repeatedly in the same region five times.
Δ: The adhesive layers remained intact even after the adhesive layers are adhered and separated repeatedly in the same region three times.
x: One or both of the adhesive layers were peeled off after the adhesive layers are adhered and separated only once.

### <Adhesive Strength to SUS>

The adhesive strength (180-degree peel adhesion strength) was determined according to the “Testing methods of pressure-sensitive adhesive tapes and sheets” specified in JIS Z 0237.

### <Adhesive Strength to Polycarbonate>

The adhesive strength (180-degree peel adhesion strength) was determined according to the “Testing methods of pressure-sensitive adhesive tapes and sheets” specified in JIS Z 0237.

### <Ball Tack>

The ball tack was determined according to the “Testing methods of pressure-sensitive adhesive tapes and sheets” specified in JIS Z 0237.

### <Re-Peeling Efficiency>

The adhesive film was adhered to a SUS plate, heated at 60° C. for 24 hours and cooled at room temperature for 2 hours. The adhesive film was then separated manually from the SUS plate. The adhesive remaining on the SUS plated was evaluated by visual observation.

◯: Favorable (no remaining adhesive, demanding no cleaning before repeated adhesion)
x: Unfavorable (remaining adhesive observed, demanding cleaning before repeated adhesion)

### <Followability to Surface Irregularity>

An adhesive film of 5 cm square was adhered to a damaged uneven-surfaced 7-cm square polycarbonate plate (surface roughness (Ra): 10 μm according to JIS B 0601) and the presence of air bubbles incorporated therein was evaluated by visual observation in the following manner.

◯: Favorable (no air bubble observed, as the film was followable to surface irregularity)
x: Unfavorable (air bubbles observed, as the film was not favorably followable to surface irregularity)

### Example 1

The ingredients in the blending composition shown in Table 1 were bilayer-coextrusion-molded, using two 40 mmφ extruders and a multimanifold die having a width 300 mm and a slit of 0.5 mm, to give a laminated polyvinylidene fluoride resin film having layers A and B. The chill roll used closest to the die of the drawing apparatus was cooled with water. An acrylic adhesive prepared in the composition ratio shown in Table 1 was coated on a paper separator (SLB-50BD, produced by Sumika-Kakoushi) to have a thickness of 10 μm and, after drying, transferred onto the layer B of the polyvinylidene fluoride resin film, to give a polyvinylidene fluoride resin adhesive film. Results of the evaluation of various properties are summarized in Table 1.

### Examples 2 to 15

A polyvinylidene fluoride resin adhesive film was prepared in a manner similar to Example 1, except that the resin blending ratio and others were changed to those shown in Table 1. Results of the evaluation of various properties are summarized in Table 1.

### Comparative Examples 1 to 4

A polyvinylidene fluoride resin adhesive film was prepared in a manner similar to Example 1, except that the resin blending ratio and others were changed to those shown in Table 2. Results of the evaluation of various properties are summarized in Table 2.

TABLE 1

| | | Example | | | | | | | |
|---|---|---|---|---|---|---|---|---|---|
| Item | | 1 | 2 | 3 | 4 | 5 | 6 | 7 | 8 |
| Resin blending ratio of layer A (K-720/HBS) | | 80/20 | 60/40 | 80/20 | 80/20 | 80/20 | 80/20 | 80/20 | 80/20 |
| Thickness of layer A (μm) | | 15 | 15 | 20 | 15 | 50 | 50 | 50 | 50 |
| Resin blending ratio of layer B (K-720/HBS) | | 20/80 | 40/60 | 20/80 | 20/80 | 20/80 | 20/80 | 20/80 | 20/80 |
| Thickness of layer B (μm) | | 30 | 30 | 20 | 30 | 50 | 50 | 50 | 100 |
| Ultraviolet absorbent in layer B | | 1.0 | 1.0 | 0.5 | 5.0 | 1.0 | 1.0 | 1.0 | 0.3 |
| Ultraviolet absorbent | | triazine-based | | | | | | | |
| Acrylic copolymer/crosslinking agent ratio | | 100/1.5 | 100/1.5 | 100/1.5 | 100/1.5 | 100/1.5 | 100/2 | 100/1 | 100/1.5 |
| Thickness of acrylic adhesive layer (μm) | | 10 | 100 | 50 | 50 | 50 | 50 | 50 | 50 |
| Storage modulus G′ of acrylic adhesive | | 7.7 × 10⁴ | 7.7 × 10⁴ | 7.7 × 10⁴ | 7.7 × 10⁴ | 7.7 × 10⁴ | 5.6 × 10⁵ | 2.3 × 10⁴ | 7.7 × 10⁴ |
| Storage modulus tan δ of acrylic adhesive | | 0.29 | 0.29 | 0.29 | 0.29 | 0.29 | 0.13 | 0.49 | 0.29 |
| Stain resistance | | ⊚ | ◯ | ⊚ | ⊚ | ⊚ | ⊚ | ⊚ | ⊚ |
| Substrate-protecting | 500 hr | 0.3 | 0.2 | 0.3 | 0.1 | 0.1 | 0.1 | 0.1 | 0.3 |
| efficiency( [symbol] b) | 1500 hr | 0.5 | 0.5 | 0.5 | 0.3 | 0.2 | 0.2 | 0.2 | 0.4 |

| | | | | | | | | |
|---|---|---|---|---|---|---|---|---|
| Adhesiveness to adhesive agent | ⊚ | ⊚ | ⊚ | ⊚ | ⊚ | ⊚ | ⊚ | ⊚ |
| Adhesive strength to SUS (N/10 mm) | 3 | 12 | 8 | 8 | 8 | 6 | 9 | 12 |
| Adhesive strength to polycarbonate (N/10 mm) | 4 | 14 | 11 | 11 | 11 | 9 | 12 | 14 |
| Ball tack (No.) | 2 | 13 | 7 | 7 | 7 | 4 | 10 | 7 |
| Re-peeling efficiency | ◯ | ◯ | ◯ | ◯ | ◯ | ◯ | ◯ | ◯ |
| Followability to surface irregularity | ◯ | ◯ | ◯ | ◯ | ◯ | ◯ | ◯ | ◯ |

| | | Example | | | | | | |
|---|---|---|---|---|---|---|---|---|
| Item | | 9 | 10 | 11 | 12 | 13 | 14 | 15 |
| Resin blending ratio of layer A (K-720/HBS) | | 80/20 | 80/20 | 80/20 | 80/20 | 80/20 | 80/20 | 80/20 |
| Thickness of layer A (μm) | | 15 | 3 | 20 | 50 | 50 | 50 | 50 |
| Resin blending ratio of layer B (K-720/HBS) | | 20/80 | 20/80 | 20/80 | 20/80 | 20/80 | 20/80 | 20/80 |
| Thickness of layer B (μm) | | 30 | 20 | 3 | 50 | 50 | 50 | 50 |
| Ultraviolet absorbent in layer B | | 1.0 | 0.5 | 5.0 | 1.0 | 1.0 | 1.0 | 1.0 |
| Ultraviolet absorbent | | benzotriazole- | triazine-based | | | | | |
| | | based | | | | | | |
| Acrylic copolymer/crosslinking agent ratio | | 100/1.5 | 100/1.5 | 100/1.5 | 100/1.5 | 100/1.5 | 100/5 | 100/0 |
| Thickness of acrylic adhesive layer (μm) | | 50 | 50 | 50 | 5 | 150 | 50 | 50 |
| Storage modulus G′ of acrylic adhesive | | 7.7 × 10⁴ | 7.7 × 10⁴ | 7.7 × 10⁴ | 7.7 × 10⁴ | 7.7 × 10⁴ | 1.5 × 10⁶ | 8.8 × 10³ |
| Storage modulus tan δ of acrylic adhesive | | 0.29 | 0.29 | 0.29 | 0.29 | 0.29 | 0.05 | 0.7 |
| Stain resistance | | ⊚ | Δ | ⊚ | ⊚ | ⊚ | ⊚ | ⊚ |
| Substrate-protecting | 500 hr | 0.3 | 0.3 | 1.2 | 0.3 | 0.3 | 0.3 | 0.3 |
| efficiency( [symbol] b) | 1500 hr | 1.1 | 0.5 | 3.5 | 0.5 | 0.5 | 0.5 | 0.5 |

| | | | | | | | |
|---|---|---|---|---|---|---|---|
| Adhesiveness to adhesive agent | ⊚ | ⊚ | Δ | ⊚ | ⊚ | ⊚ | ⊚ |
| Adhesive strength to SUS (N/10 mm) | 8 | 8 | 8 | 1 | 22 | 3 | 10 |
| Adhesive strength to polycarbonate (N/10 mm) | 11 | 11 | 11 | 1.8 | 23 | 4 | 12 |
| Ball tack (No.) | 7 | 7 | 7 | <1 | 24 | <1 | 10 |
| Re-peeling efficiency | ◯ | ◯ | ◯ | ◯ | Δ | ◯ | Δ |
| Followability to surface irregularity | ◯ | ◯ | ◯ | Δ | ◯ | Δ | ◯ |

TABLE 2

| | | Comparative | Comparative | Comparative | Comparative |
|---|---|---|---|---|---|
| Item | | Example 1 | Example 2 | Example 3 | Example 4 |
| Resin blending ratio of layer A (K-720/HBS) | | 40/60 | 20/80 | 80/20 | 80/20 |
| Thickness of layer A (μm) | | 15 | 15 | 15 | 50 |
| Resin blending ratio of layer B (K-720/HBS) | | 60/40 | 80/20 | 20/80 | 20/80 |
| Thickness of layer B (μm) | | 30 | 30 | 30 | 50 |
| Ultraviolet absorbent in layer B | | 1.0 | 1.0 | 20.0 | 0.0 |
| Ultraviolet absorbent | | triazine-based | | | None |
| Acrylic copolymer/crosslinking agent ratio | | 100/1.5 | 100/1.5 | 100/1.5 | 100/1.5 |
| Thickness of acrylic adhesive layer (μm) | | 50 | 50 | 50 | 50 |
| Storage modulus G′ of acrylic adhesive | | 7.7 × 10⁴ | 7.7 × 10⁴ | 7.7 × 10⁴ | 7.7 × 10⁴ |
| Storage modulus tan δ of acrylic adhesive | | 0.29 | 0.29 | 0.29 | 0.29 |
| Stain resistance | | Δ | X | ⊚ | ⊚ |
| Substrate-protecting efficiency ( [symbol] b) | 500 hr | 0.2 | 0.4 | 0.3 | 3.6 |
| | 1500 hr | 0.5 | 0.9 | 0.5 | 7.3 |

| | | | | |
|---|---|---|---|---|
| Adhesiveness to adhesive agent | Δ | X | Δ | ⊚ |
| Adhesive strength to SUS (N/10 mm) | 8 | 8 | 1 | 8 |
| Adhesive strength to polycarbonate (N/10 mm) | 11 | 11 | 1.5 | 11 |
| Ball tack (No.) | 7 | 7 | <1 | 7 |
| Re-peeling efficiency | ◯ | ◯ | ◯ | ◯ |
| Followability to surface irregularity | ◯ | ◯ | ◯ | ◯ |

As shown in Table 1, the polyvinylidene fluoride resin adhesive films of Examples 1 to 15 were mostly favorable in stain resistance, substrate-protecting efficiency (long-term weather fastness), adhesiveness to adhesive agent, re-peeling efficiency, and followability to surface irregularity.

On the other hand, as shown in Table 2, the polyvinylidene fluoride resin adhesive films of Comparative Examples 1 and 2, wherein the resin blending ratio of layer A to layer B is outside the range of the present invention, were found to be lower in stain resistance and adhesiveness to adhesive agent than those of Examples.

Alternatively, the polyvinylidene fluoride resin adhesive film of Comparative Example 3, wherein the content of the ultraviolet absorbent in layer B is more than 15 mass %, was found to be slightly lower in adhesiveness to adhesive agent and lower in adhesive strengths to SUS and polycarbonate and lead to separation over time after application.

Yet alternatively, the polyvinylidene fluoride resin adhesive film of Comparative Example 4, wherein the layer B does not contain any ultraviolet absorbent, was found to be very inferior in substrate-protecting efficiency (long-term weather fastness).

When the polyvinylidene fluoride resin adhesive films were compared between Examples, the polyvinylidene fluoride resin adhesive films of Examples, wherein the layer A has a thickness of 5 μm to 100 μm, were found to be superior in stain resistance to the polyvinylidene fluoride resin adhesive film of Example 10, wherein layer A has a thickness of less than 5 μm. The result shows that the thickness of the layer A is preferably designed to be 5 μm to 100 μm.

In addition, the polyvinylidene fluoride resin adhesive films of Examples, wherein the layer B has a thickness of 5 μm to 100 μm were found to be better in adhesiveness to adhesive agent and higher in substrate-protecting efficiency (long-term weather fastness) than the polyvinylidene fluoride resin adhesive film of Example 11, wherein the layer B has a thickness of less than 5 μm. The result shows that the thickness of the layer B is preferably designed to be 5 μm to 100 μm.

Further, the polyvinylidene fluoride resin adhesive films of Examples 1 to 11, 14, and 15, wherein the acrylic adhesive layer has a thickness of 10 μm to 100 μm, were found to be favorably superior in adhesive strength to SUS and adhesive strength to polycarbonate, lead to no separation over time after application, and is superior in followability to surface irregularity, as compared to the polyvinylidene fluoride resin adhesive film of Example 12, wherein the acrylic adhesive layer has a thickness of less than 10 μm. Further, the polyvinylidene fluoride resin adhesive film of Examples 1 to 11, 14, and 15, wherein the acrylic adhesive layer has a thickness of 10 μm to 100 μm, was found to be favorably superior in adhesive strengths to SUS and polycarbonate, lead to no separation over time after application, and have a ball tack of less than No. 15, show favorable tackiness, permit reliable operation during positioning and re-application of the film and has favorable re-peeling efficiency, as compared to the polyvinylidene fluoride resin adhesive films of Example 13, wherein the acrylic adhesive layer has a thickness of more than 100 μm. These results show that the thickness of the acrylic adhesive layer is preferably designed to be 10 μm to 100 μm.

In addition, the polyvinylidene fluoride resin adhesive film of Examples, wherein the acrylic adhesive has a storage modulus at 25° C. and 1.0 Hz of 1.0×10⁴ to 1.0×10⁶ Pa were found to be superior in followability to surface irregularity to the polyvinylidene fluoride resin adhesive film of Example 14, wherein the acrylic adhesive has a storage modulus at 25° C. and 1.0 Hz of more than 1.0×10⁶ Pa. Further, the polyvinylidene fluoride resin adhesive film of Examples, wherein the acrylic adhesive has a storage modulus at 25° C. and 1.0 Hz of 1.0×10⁴ to 1.0×10⁶ Pa and a tan δ at 100° C. and 1.0 Hz of 0.6 or less, were found to be superior in re-peeling efficiency to the polyvinylidene fluoride resin adhesive film of Example 15, wherein the acrylic adhesive has a storage modulus at 25° C. and 1.0 Hz of less than 1.0×10⁴ Pa and a tan δ at 100° C. and 1.0 Hz of more than 0.6. These results show that the acrylic adhesive preferably has a storage modulus at 25° C. and 1.0 Hz of 1.0×10⁴ to 1.0×10⁶ Pa and a tan δ at 100° C. and 1.0 Hz of 0.6 or less.

### INDUSTRIAL APPLICABILITY

It is expected, by using the adhesive film according to the present invention, that it is possible to restore the transparency of a damaged surface-irregular transparent base material for example of glass or a transparent plastic by smoothing the surface irregularity generated thereon and to contribute to improved surface protection, for example in weather fastness and stain resistance after application, of the transparent base material. Because the adhesive film according to the present invention can be used as a repair and protection adhesive film for transparent parts of constructions, the repair method employing the adhesive film according to the present invention is higher in usefulness.

1. A polyvinylidene fluoride resin adhesive film, comprising a layer B, a layer A laminated on one face thereof and an acrylic adhesive layer formed on the other face thereof, wherein:
the layer A is a resin composition containing a polyvinylidene fluoride resin in an amount of 100 to 50 mass % and a polymethacrylic ester resin in an amount of 0 to 50 mass % (100% in total); and
the layer B is a resin composition containing a polyvinylidene fluoride resin in an amount of 0 to 50 mass % and a polymethacrylic ester resin in an amount of 100 to 50 mass % (100% in total) and additionally an ultraviolet absorbent in an amount of 0.1 to 15 mass % with respect to the resin components of the layer B.

2. The polyvinylidene fluoride resin adhesive film according to claim 1, wherein the layer A has a thickness of 5 μm to 100 μm and the layer B has a thickness of 5 μm to 100 μm.

3. The polyvinylidene fluoride resin adhesive film according to claim 1, wherein the ultraviolet absorbent contained in the layer B is a triazine compound.

4. The polyvinylidene fluoride resin adhesive film according to claim 1, wherein the acrylic adhesive layer has a thickness of 10 μm to 100 μm.

5. The polyvinylidene fluoride resin adhesive film according to claim 1, wherein the acrylic adhesive has a storage modulus at 25° C. and 1.0 Hz of 1.0×104 to 1.0×106 Pa, and a tan δ at 100° C. and 1.0 Hz of 0.6 or less.

6. The polyvinylidene fluoride resin adhesive film according to claim 1, wherein the surface of the acrylic adhesive layer of the polyvinylidene fluoride resin adhesive film is protected with a separator.

7. An adhesive film for repair of a transparent base material, comprising the polyvinylidene fluoride resin adhesive film according to claim 1.

8. A repair method, employing the adhesive film for repair of the transparent base material according to claim 7.
